(19) United States
(12) Patent Application Publication
(10) Pub. No.: US 2008/0209741 A1
(43) Pub. Date: Sep. 4, 2008

(54) Blade structure of an electric hair trimmer

(76) Inventors: Chin-Chuan Chen, Hsin-Chuang City (TW); Yu-Hsia Chen Yang, Hsin-Chuang City (TW); Cheng-I Chen, Hsin-Chuang City (TW); Cheng-Hsiang Chen, Hsin-Chuang City (TW)

Correspondence Address: TROXELL LAW OFFICE PLLC, SUITE 1404, 5205 LEESBURG PIKE, FALLS CHURCH, VA, 22041, US

(21) Appl. No.: 11/713,093

(22) Filed: Mar. 2, 2007

(51) Int. Cl. B26B 19/38

(52) U.S. Cl. 30/238; 30/355

(57) ABSTRACT

A blade structure of an electric hair trimmer is a blade set, comprising a fixed blade, a movable blade and a vibration seat which is driven by a motor. A front end of both fixed and movable blades is provided with a plurality of teeth to cut the hair by an alternate movement. The lower sections of edge parts at two sides of a tooth of the movable blade are extended outward from top to bottom to form with externally expanded surfaces with sharp transection angles. Accordingly, when hair is cut, a contact area of the edge parts between the hair is decreased, to largely reduce resistance to cutting, such that the hair can be cut off well with improved speed and efficiency and can be prevented from being damaged. Besides, lifetime of usage of blade structure in the electric hair trimmer can be extended.

### BACKGROUND OF THE INVENTION

(a) Field of the Invention

The present invention relates to a blade structure of an electric hair trimmer, and more particularly to a blade structure which is provided with less resistance to cutting, such that hair can be quickly and smoothly trimmed off.

(b) Description of the Prior Art

A blade set of a conventional electric hair trimmer is located at a front end of a body. The blade set is primarily constituted by a lower fixed blade which is overlapped with an upper movable blade connected to a vibration seat. The movable blade is linked by the vibration seat, which is driven by a motor in an interior of the body, to move reciprocally towards left and right, thereby forming alternate to-and-for movement with the fixed blade to trim the hair.

Referring to FIG. 1 and FIG. 2, a front end of the movable blade is usually composed of a plurality of teeth A, to form a saw-tooth shape. Sides of each tooth A are blade edges B which are in contact with hair C to cut it off. The blade edge B is in a shape of a little tilted straight-line and is near vertical, in a cross-sectional view. Therefore, when the movable blade moves towards left and right to alternate with the fixed blade for creating shear force, the blade edge B is almost in contact with the hair in a plane. As a contact area is large, resistant force is correspondingly stronger; therefore, when cutting the hair, it will be harder to drive the motor in the body, and the hair is not easy to be cut off smoothly and quickly. Accordingly, the hair is usually jammed or is cut off by forcefully pulling and dragging, thereby being damaged. In addition, effect and speed of hair cutting are greatly reduced, and the blade edge parts are also damaged easily. As the hair is not easy to be cut off, cutting time will be increased too, and the motor will be overheated by overloading, thereby easily resulting in a quick worn-out to the hair trimmer and shortening its lifetime of usage. Accordingly, a conventional electric hair trimmer is still not in compliance with a user's requirement well, and thus requires improvement.

### SUMMARY OF THE INVENTION

The primary object of present invention is to provide a blade structure of an electric hair trimmer, which is provided with less resistance, can quickly and smoothly cut hair, and has a better cutting effect.

Another object of the present invention is to provide a blade structure of an electric hair trimmer, which requires less effort for cutting and can extend lifetime of usage of the hair trimmer.

Still another object of the present invention is to provide a blade structure of an electric hair trimmer, which can prevent hairlines from moving and enclose more hairs, to increase cutting speed.

Accordingly, a front end of a movable blade and a fixed blade of an electric hair trimmer is provided with a plurality of teeth, sides of each tooth of the movable blade are formed with edge parts to contact and cut the hair, and lower sections of the edge parts are extended outward from top to bottom, thereby forming externally expanded surfaces with sharp transection angles. Accordingly, when the movable blade and the fixed blade alternate to cut the hair, a contact area between the edge parts of the movable blade and the hair will be smaller, and resistance to cutting will be largely reduced, such that the hair can be quickly cut off well, and a motor can be prevented from being overloaded to extend lifetime of usage of the electric hair trimmer. On the other hand, the edge parts of the movable blade can be formed with a plurality of continuous grooves, to hold and enclose more hair and prevent the hairlines from sliding outward, thereby enabling the cutting to be more quickly and efficiently accomplished.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional movable blade.

FIG. 2 shows a cross-sectional view of a conventional movable blade in cutting hair.

FIG. 3 shows a perspective view of a structure of the hair trimmer.

FIG. 4 shows a perspective view of a first embodiment of the present invention.

FIG. 5 shows an exploded view of a single tooth of the present invention.

FIG. 6 shows a cross-sectional view along a line A-A′ of FIG. 5.

FIG. 7 shows a schematic view of hair cutting in FIG. 6.

FIG. 8 shows a cross-sectional view of a tooth of a second embodiment of the present invention.

FIG. 9 shows a schematic view of hair cutting in FIG. 8.

FIG. 10 shows a cross-sectional view of a tooth of a third embodiment of the present invention.

FIG. 11 shows a schematic view of hair cutting in FIG. 10.

FIG. 12 shows a cross-sectional view of a tooth of a fourth embodiment of the present invention.

FIG. 13 shows a schematic view of hair cutting in FIG. 12.

FIG. 14 shows a cross-sectional view of a tooth of a fifth embodiment of the present invention.

FIG. 15 shows a schematic view of hair cutting in FIG. 14.

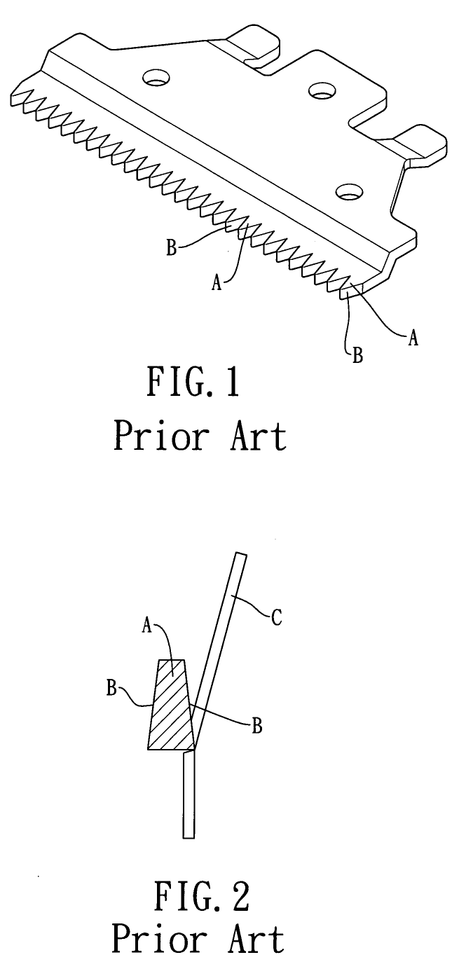

### DETAILED DESCRIPTION OF THE PREFERRED EMBODIMENTS

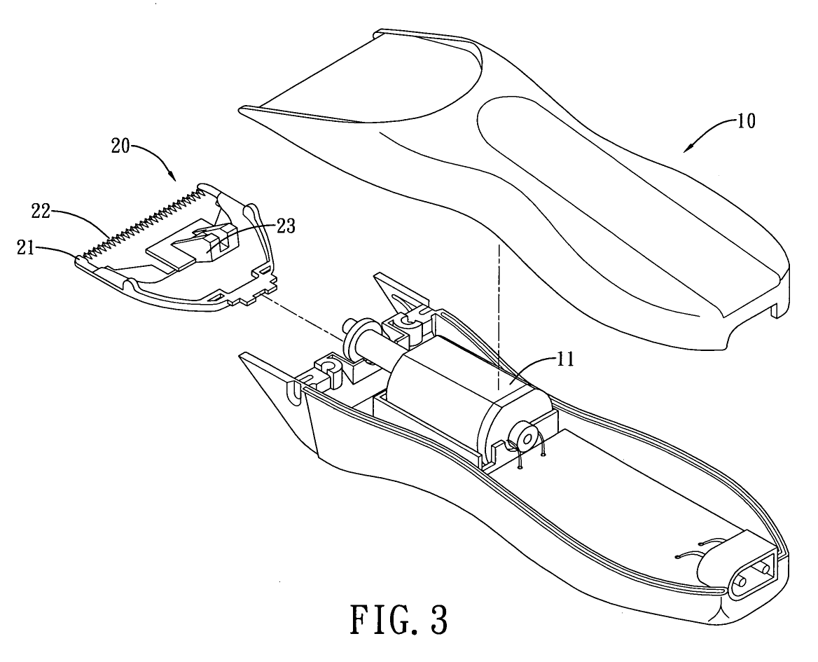

Referring to FIG. 3, it shows a perspective view of a body 10 structure of the electric hair trimmer comprising with a front blade set 20 which contains a fixed blade 21 and a movable blade 22 both provided with a plurality of teeth, and with a vibration seat 23 which is connected to a movable blade 22. The vibration seat 23 is driven by a motor 11 configured in the interior of the body 10, enabling the movable blade 22 to be overlapped with the fixed blade 21 to form an alternate movement.

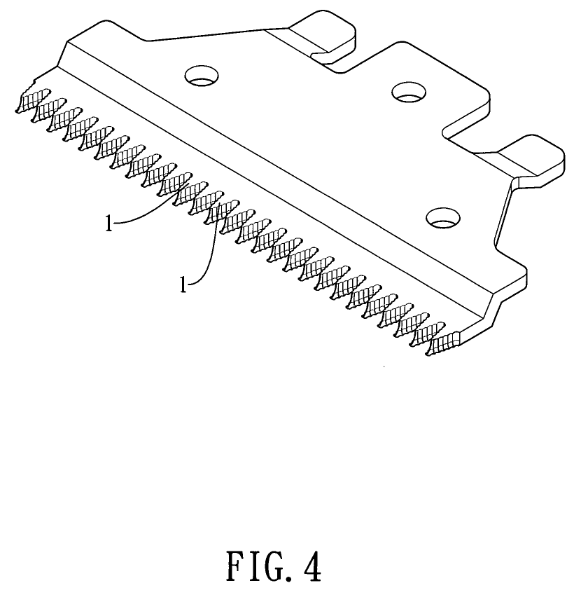

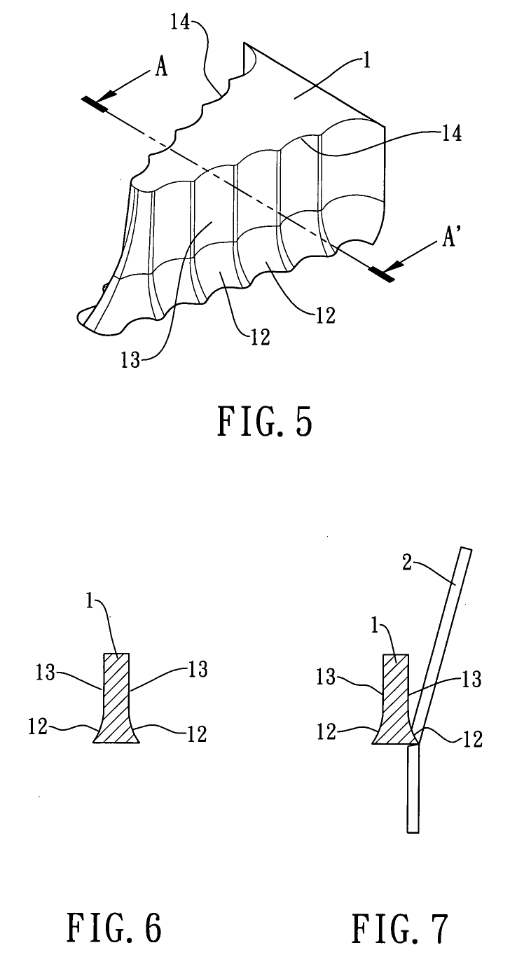

Referring to FIG. 4 and FIG. 5, it shows a perspective view of a first embodiment of a movable blade, and an enlarged view of a single tooth of the present invention. A front end of that movable blade 22 is provided with a plurality of teeth 1 in a shape of a triangular saw-tooth, and two sides of each tooth 1 are formed with edge parts 13 which contact and cut off hair. Referring to FIG. 6, which is a schematic view of a cross-section along a line A-A′ of FIG. 5, upper sections of the edge parts 13 are in a straight-line shape and lower sections are extended outward from top to bottom in an arc-line shape, to form externally expanded surfaces 12 with sharp transection angles, if viewing along the cross section. The edge parts 13 are provided with a plurality of arc-shape and continuous grooves 14 which are extended outward in arc lines at the lower sections of the edge parts 13, enabling the lower sections of the edge parts 13 to form arc surfaces like waves.

Referring to FIG. 7, sharp cutting angles are formed by the externally expanded surfaces 12 at lower ends of the edge parts 13, and when the movable blade moves reciprocally in a transversal direction to cut hair 2, its contact area with the hair is decreased due to the sharp transection angles formed by the externally expanded surfaces 12 at the lower ends of the edge parts 13, and thus entire resistance withstood by the edge parts 13 is largely reduced, thereby allowing the hair 2 to be quickly cut off well, and largely improving speed of hair cutting. As the hair 2 can be quickly cut off, the hair 2 will not be pulled and dragged, and an effect of beauty in hair cutting is much better than it used to have. In addition, the hair 2 can be prevented from being damaged, and blade edges are not easier to be worn out. When the hair 2 is cut off well and smoothly, a motor 11 in an interior of machine body can also operate smoothly, without being overloaded, such that lifetime of usage of the motor 11 can be extended.

When cutting the hair 2, the aforementioned arc-shape continuous grooves 14 can hold and enclose larger quantity of hairlines, thereby preventing the hairlines from sliding outward to be released in cutting. Accordingly, large amount of the hair can be cut off well, and the speed and efficiency of hair cutting are more improved, while in collaboration with the aforementioned externally expanded surfaces 12 with the sharp cutting angles.

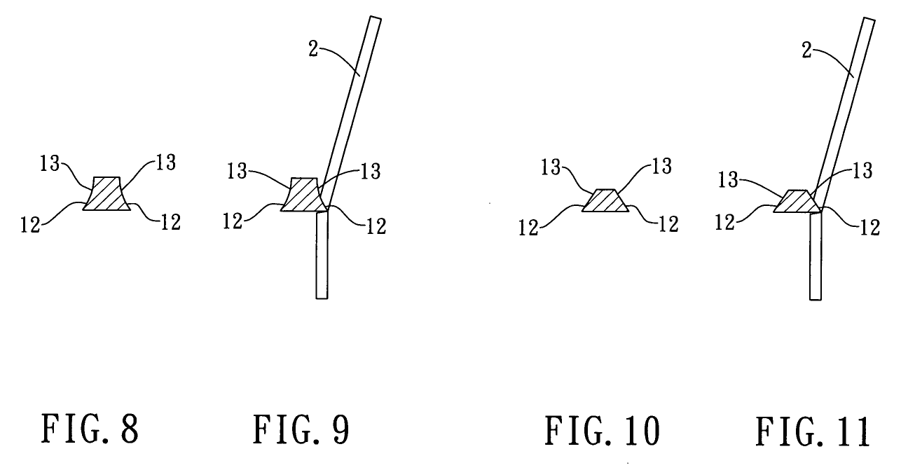

Referring to FIG. 8 and FIG. 9, it shows a cross-sectional view of a tooth of a second embodiment of the present invention, and a schematic view of hair cutting in FIG. 8, respectively. Thickness of the movable blade 22 can be decreased in accordance with strength of material, the edge parts 13 are formed with arc lines which are extended outward from top to bottom, and the lower sections of the edge parts 13 are also formed with the externally expanded surfaces 12 having the sharp transection angles, to reduce the contact area between the hair 2, thereby decreasing the resistance to cutting.

Referring to FIG. 10 and FIG. 11, it shows a cross-sectional view of a tooth of a third embodiment of the present invention, and a schematic view of hair cutting in FIG. 10, respectively. When the thickness of blade is smaller, the edge parts 13 are extended outward from top to bottom in straight lines, enabling the externally expanded surfaces 12 at lower ends to form the sharp cutting angles to cut the hair 2 quickly.

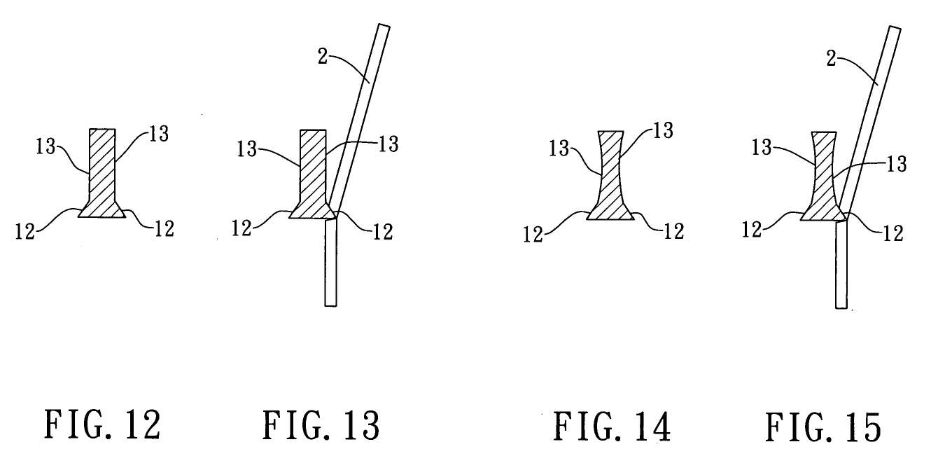

Referring to FIG. 12 and FIG. 13, it shows a cross-sectional view of a tooth of a fourth embodiment of the present invention, and a schematic view of hair cutting in FIG. 12, respectively. Upper sections of the edge parts 13 are in a shape of straight lines extending from top to bottom, and the externally expanded surfaces 12 at lower sections are formed with straight lines which are extended outward from top to bottom, so as to decrease a contact area between the hair 2, and to provide the cutting angles with less resistance.

Referring to FIG. 14 and FIG. 15, it shows a cross-sectional view of a tooth of a fifth embodiment of the present invention, and a schematic view of hair cutting in FIG. 14, respectively. Upper sections of the edge parts 13 are in a shape of arc lines, and the externally expanded surfaces 12 at lower sections are in a shape of straight lines which are extended outward.

Accordingly, by the sharp transection angles formed by the externally expanded surfaces 12 which are extended outward at the lower ends of the edge parts 13, the resistance to cutting is largely reduced, which indeed achieves the expected object of the present invention that the blade structure which can quickly and smoothly cut the hair 2 is provided.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A blade structure of an electric hair trimmer, comprising a blade set which is installed at a front end of a electric hair trimmer, with the blade set being constituted by a fixed blade and a vibration seat which is connected to a movable blade, with a front end of the fixed blade and the movable blade being provided with a plurality of teeth, and with the vibration seat being driven by a motor in an interior of the body, enabling the movable blade to be overlapped with the fixed blade to form alternate movement; lower sections of edge parts of the movable blade being extended outward to form externally expanded surfaces having sharp transection angles.

2. The blade structure of an electric hair trimmer according to claim 1, wherein the edge parts of the movable blade are provided with arc-shape continuous grooves.

3. The blade structure of an electric hair trimmer according to claim 1, wherein upper sections at a cross-section of the edge parts of the movable blade are in a straight-line shape, and lower sections are extended outward from top to bottom in an arc-line shape.

4. The blade structure of an electric hair trimmer according to claim 2, wherein upper sections at a cross-section of the edge parts of the movable blade are in a straight-line shape, and lower sections are extended outward from top to bottom in an arc-line shape.

5. The blade structure of an electric hair trimmer according to claim 1, wherein the edge parts of the movable blade are extended outward from top to bottom in an arc-line shape.

6. The blade structure of an electric hair trimmer according to claim 2, wherein the edge parts of the movable blade are extended outward from top to bottom in an arc-line shape.

7. The blade structure of an electric hair trimmer according to claim 1, wherein the edge parts of the movable blade are extended outward from top to bottom in a straight-line shape.

8. The blade structure of an electric hair trimmer according to claim 2, wherein the edge parts of the movable blade are extended outward from top to bottom in a straight-line shape.

9. The blade structure of an electric hair trimmer according to claim 1, wherein upper sections at a cross section of the edge parts of the movable blade are in a straight-line shape, and lower sections are extended outward from top to bottom in a straight-line shape.

10. The blade structure of an electric hair trimmer according to claim 2, wherein upper sections at a cross section of the edge parts of the movable blade are in a straight-line shape, and lower sections are extended outward from top to bottom in a straight-line shape.

11. The blade structure of an electric hair trimmer according to claim 1, wherein upper sections at a cross section of the edge parts of the movable blade are in an arc-line shape, and lower sections are extended outward from top to bottom in a straight-line shape.

12. The blade structure of an electric hair trimmer according to claim 2, wherein upper sections at a cross section of the edge parts of the movable blade are in an arc-line shape, and lower sections are extended outward from top to bottom in a straight-line shape.
